(19) United States
(12) Patent Application Publication
(10) Pub. No.: US 2024/0201062 A1
(43) Pub. Date: Jun. 20, 2024

(54) METHOD AND APPARATUS FOR DETERMINING PARTICLE CONTENT IN A FLUID, COMPUTER READABLE MEDIUM

(71) Applicant: Aktiebolaget SKF, Göteborg (SE)

(72) Inventors: Gang CHENG, Shanghai (CN); Tao FENG, Suzhou (CN); Jinshi CUI, Shanghai (CN)

(21) Appl. No.: 18/530,814

(22) Filed: Dec. 6, 2023

(30) Foreign Application Priority Data
Dec. 14, 2022 (CN) 202211611443.5

(51) Int. Cl. G01N 15/0227; G06T 5/70; G06T 7/00; G06T 7/11; G06V 10/26; G06V 10/30; G06V 10/75

(52) U.S. Cl. CPC G01N 15/0227; G06T 5/70; G06T 7/0008; G06T 7/11; G06V 10/26; G06V 10/30; G06V 10/758

(57) ABSTRACT

The present disclosure relates to a method for determining particle content in a fluid. The method includes acquiring an image of the fluid, determining a particle-related characteristic value in the image, and determining the particle content from the particle-related characteristic value. Furthermore, the present disclosure also relates to an apparatus and a computer readable medium for determining particle content in a fluid.

### CROSS-REFERENCE TO RELATED APPLICATION

This application claims priority to Chinese Application No. 202211611443.5, filed Dec. 14, 2022, the entirety of which is hereby incorporated by reference.

### FIELD

The present disclosure relates to a method for determining particle content in a fluid, an apparatus for determining particle content in a fluid, and a computer readable medium.

### BACKGROUND

In the operation of the mechanical device, it is necessary to lubricate the running device with lubricating fluid or oil to reduce friction between parts in the mechanical device, thereby improving the performance of the mechanical device and protecting the mechanical device. Therefore, for a better lubrication effect, the lubrication fluid or lubricating oil needs to maintain a good lubrication condition. Conversely, poor lubrication conditions can lead to early operational anomalies and later failure or damage of the mechanical device.

Therefore, it is important to understand the lubrication condition of lubricating fluid or oil. Conventional detection methods require a special detection device or require a long detection time. Therefore, it is necessary to develop a new detection method in order to more simply and quickly determine the lubrication condition of a lubricating fluid or oil.

### SUMMARY

Embodiments of the present disclosure provide a method for determining particle content in a fluid and an apparatus for determining particle content in a fluid. The method and the apparatus according to embodiments of the present disclosure enable more rapid determination of the condition of the corresponding fluid, e.g., the lubrication condition of a lubricating fluid or a lubricating oil, from an image of the fluid.

Embodiments of the present disclosure provide a method for determining particle content in a fluid, the method comprising acquiring an image of the fluid, determining a particle-related characteristic value in the image, and determining the particle content from the particle-related characteristic value.

According to an embodiment of the present disclosure, the particle-related characteristic value includes a statistical characteristic value of the values of the pixels in the image, the number, density, and total area of the particles, a statistical characteristic value of the values of the pixels after removing the particles from the image, and a statistical characteristic value of the values of the pixels after removing the particles from the image and removing noise of the image.

According to an embodiment of the present disclosure, the statistical characteristic value of the values of the pixels in the image includes: a mean, a variance, a skewness, and a kurtosis of the values of the pixels in the image.

According to an embodiment of the present disclosure, determining the particle-related characteristic value in the image includes: preprocessing the image, wherein preprocessing the image includes: segmenting the image to obtain a preprocessed image with a predetermined size and a predetermined position, normalizing the values of the pixels in the image, removing noise of the image, and converting the image into an image with a predetermined format.

According to an embodiment of the present disclosure, the predetermined format includes an RGB format and an HSV format.

According to an embodiment of the present disclosure, determining the particle content from the particle-related characteristic value includes: determining the particle content from the particle-related characteristic value based on a regression model, wherein the regression model describes a relationship between the particle-related characteristic value and the particle content.

According to an embodiment of the present disclosure, the method further includes: determining that further detection of the fluid is required in the event that the particle content is greater than a first threshold and less than a second threshold, wherein the first threshold is less than the second threshold, determining that a replacement of the fluid is required in the event that the particle content is greater than the second threshold.

Embodiments of the present disclosure also provide an apparatus for determining particle content in a fluid, the apparatus includes an image acquisition unit for acquiring an image of the fluid; a characteristic value determination unit for determining a particle-related characteristic value in the image; and a particle content determination unit for determining the particle content from the particle-related characteristic value.

Embodiments of the present disclosure also provide a computer readable medium having a computer program product stored on the computer readable medium which can be directly loaded into a memory unit of a programmable computing unit, the computer program product having program code means for performing the above-mentioned method for determining particle content in a fluid when the computer program product is implemented in the computing unit.

The method, the apparatus and the computer-readable medium according to the present disclosure may enable the content of particles, e.g. iron particles, to be determined in a fluid to be tested, e.g. a lubricating fluid or a lubricating oil, only by means of an image thereof. Thus, the maintenance personnel of the machine device can easily and quickly perform the test in the field, thereby eliminating the need to take a sample of the fluid back to the laboratory for the test, and eliminating the need to use a special test device for the test.

### BRIEF DESCRIPTION OF THE DRAWINGS

In order to more clearly illustrate the technical solutions of the embodiments of the present disclosure, the following will simply introduce the accompanying drawings that are needed to be used in the description of the embodiments. The drawings in the following description are merely exemplary embodiments of the present disclosure.

FIG. 1 illustrates a flow chart of a method for determining particle content in a fluid according to an embodiment of the present disclosure,

FIG. 2 illustrates a flow chart of another method for determining particle content in a fluid according to an embodiment of the present disclosure,

FIG. 3 illustrates a flow chart of a method for determining the state of a fluid from the particle content in the fluid according to an embodiment of the present disclosure,

FIG. 4 illustrates a structural schematic diagram of an apparatus for determining particle content in a fluid according to an embodiment of the present disclosure, and

FIG. 5 illustrates a schematic view of an apparatus for determining particle content in a fluid according to an embodiment of the present disclosure.

### DETAILED DESCRIPTION

In order to make the objects, technical solutions, and advantages of the present disclosure more apparent, example embodiments according to the present disclosure will be described in detail below with reference to the accompanying drawings. Apparently, the described embodiments are only a part of the embodiments of the present disclosure, rather than all of the embodiments of the present disclosure, it being understood that the present disclosure is not limited by the example embodiments described herein.

In the present specification and drawings, substantially the same or similar steps and elements are denoted with the same or similar reference numerals, and repeated descriptions of these steps and elements will be omitted. Meanwhile, in the description of the present disclosure, the terms “first,” “second,” and the like are used only to distinguish descriptions and are not to be understood as indicating or implying relative importance or ordering.

In the present specification and drawings, elements are described in singular or plural form according to an embodiment. However, the singular and plural forms are appropriately selected for the proposed cases merely for convenience of explanation and are not intended to limit the present disclosure thereto. Thus, a singular form may include a plural form, and a plural form may include a singular form as well unless the context clearly indicates otherwise. In an embodiment of the present disclosure, unless explicitly stated otherwise, “connected” does not mean necessarily “directly connected” or “directly in contact”, but only needs to be electrically in communication.

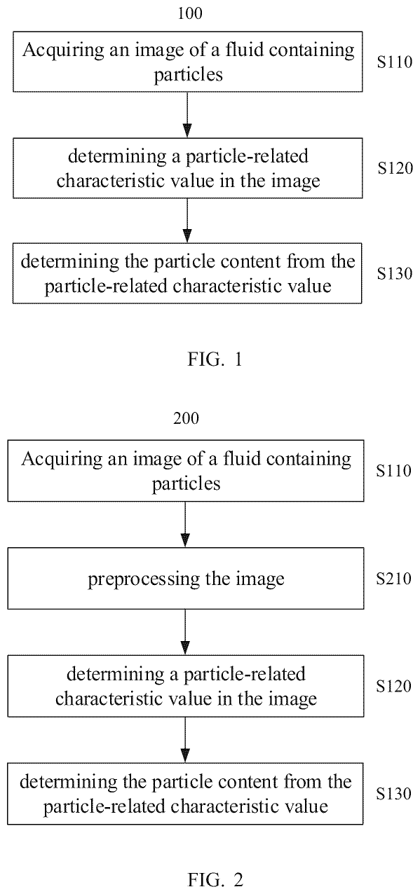

FIG. 1 illustrates a flow chart of a method 100 for determining particle content in a fluid according to an embodiment of the present disclosure. In the method 100, an image of the fluid is first acquired (step S110), then a particle-related characteristic value in the image is determined (S120), and the particle content is determined from the particle-related characteristic value (S130).

In the mechanical device, the fluid may be, e.g., a lubricating fluid and a lubricating oil, which lubricate the operation of the mechanical device, thereby reducing friction between parts in the mechanical device, and improving the performance of the mechanical device and protecting the mechanical device. The particles in the fluid may be, e.g., metal particles, such as iron particles, external particles, organic oxides, and the like in lubricating fluids and lubricating oils, wherein the metal particles originate from metal filings generated by the friction of the metal parts, the most common metal particles being iron particles; External particles, e.g., may originate from airborne pollutants, such as dust or sand particles, or maybe other pollutants carried in during operation or maintenance; The formation of organic oxides results from the oxidation, decomposition, and acidification of the lubricating oil itself.

In performing step S110, e.g., the fluid under test, such as a lubricating fluid or a lubricating oil, may first be sampled, placed on a glass slide, and amplified by an optical amplifier. An image of the magnified fluid may then be taken, e.g., by a camera. The acquired image needs to comply with predetermined image requirements, such as resolution, sharpness, saturation, hue, and the like.

Step S120 of determining a particle-related characteristic value in the image is then performed. According to an embodiment of the present disclosure, the particle-related characteristic value includes a statistical characteristic value of the values of the pixels in the image, a statistical characteristic value of the values of the pixels after the particle is removed from the image, and a statistical characteristic value of the values of the pixels after the particle is removed from the image and noise of the image is removed.

An image may, e.g., be considered to be a collection of pixels, which each have a respective value. E.g., for a grayscale image, the higher the value of a pixel, the whiter/lighter the color of that pixel, whereas, the smaller the value of a pixel, the darker/darker the color of that pixel. Further, e.g. in an RGB (red, green, blue) color image, the value of the pixel may e.g. be the value of the pixel in one of the color channels. Thus, if the value of the pixel is larger, the color is more intense and vice versa the color is less intense. Alternatively, e.g. in an HSV (hue, saturation, lightness) color image, the value of the pixel may e.g. be the value of the pixel in one of the channels. Thus, for a hue, the value of a pixel represents the corresponding color; For saturation, the value of the pixel represents a high degree of color purity; For value or luminance, the value of a pixel represents the brightness of a color.

Since the image contains particles, the size of the values of the pixels in the image may be affected by the particles, e.g. the pixels that make up the particles may have larger values. Thus, e.g., a statistical analysis may be performed for the values of the pixels and a statistical characteristic value of the values of the pixels determined. According to an embodiment of the present disclosure, the statistical characteristic values of the values of the pixels in the image include: a mean, a variance, a skewness, and a kurtosis of the values of the pixels in the image. Their specific definitions are as follows:

The mean μ of the values of the pixels is:

$$μ = \frac{1}{n} {\sum }_{i = 1}^{n} {X}_{i}$$

wherein Xᵢ denotes the value of one of the pixels with 1≤i≤n. The mean value μ reflects the overall size of the value of a pixel.

The variance σ² of the values of the pixels is:

$${σ}^{2} = \frac{1}{n} {{\sum }_{i = 1}^{n} [ {X}_{i} - μ ]}^{2}$$

wherein Xᵢ denotes the value of one of the pixels with 1≤i≤n, and μ is the mean value of the values of the pixels. The variance σ² reflects the dispersion degree of the value of a pixel, i.e., much it deviates relative to the mean value μ.

The skewness S of the value of the pixel is:

$$S = \frac{1}{n} {{\sum }_{i = 1}^{n} [ \frac{{X}_{i} - μ}{σ} ]}^{3}$$

wherein Xᵢ denotes the value of one of the pixels with 1≤i≤n, and μ is the mean value of the values of the pixels. σ is the standard deviation of the values of the pixels. S Skewness reflects the asymmetry of the probability distribution of the values of a pixel. When the skewness is 0, the values of the pixels conform to a normal distribution, the values of the pixels are uniformly distributed on both sides of the μ mean value. When the skewness S is greater than 0, the probability distribution of the values of the pixels is shifted to the right, and when the skewness S is less than 0, the probability distribution of the values of the pixels is shifted to the left.

The kurtosis K of the value of the pixel is:

$$K = \frac{1}{n} {{\sum }_{i = 1}^{n} [ \frac{{X}_{i} - μ}{σ} ]}^{4}$$

Where Xᵢ denotes the value of one of the pixels with 1≤i≤n, and μ is the mean value of the values of the pixels. σ is the standard deviation of the values of the pixels. Kurtosis reflects the degree of outlier of the values of pixels. When the kurtosis is equal to 3, the distribution of the values of the pixels conforms to a standard normal distribution. If the kurtosis is greater than 3, it means that there are more extreme values, i.e., values that deviate farther from the mean value, in the values of pixels.

Furthermore, it is e.g. also possible to first remove the particles from the image and then determine the statistical characteristic values of the values of the pixels, i.e. mean, variance, skewness and kurtosis, etc., and it is e.g. also possible to first remove the particles and remove noise of the image and then determine the statistical characteristic values of the values of the pixels, i.e. mean, variance, skewness and kurtosis, etc.

According to an embodiment of the present disclosure, the characteristic values about the particles further comprise: a number, a density and a total area of the particles in the image. After obtaining the image containing the particles, the particles may be identified from the image, e.g. the number of particles may be directly used as the particle-related characteristic value, or the density of the particles in the image may be calculated from the number of particles and the size of the image and used as the particle-related characteristic value, or the areas of all the particles may be summed to obtain the total area of the particles and used as the particle-related characteristic value.

Finally, a step S130 of determining the particle content from the particle-related characteristic value is performed. The particle-related characteristic value has a certain relationship, i.e. a functional relationship, with the particle content in the fluid. The particle content can thus be determined from particle-related characteristic value. In the simplest case, the particle content is determined, e.g., by one of the particle-related characteristic values described above. Preferably, the particle content is determined, e.g., by a plurality of the particle-related characteristic values described above, e.g. by the mean and variance of the values of the pixels in the image, the number and total area of the particles, and the variance of the values of the pixels after removing said particles from the image and removing noise of the image. In addition to this, the relation of the particle-related characteristic value to the content of the particle in the fluid may also be established, e.g., by means of artificial intelligence, such as an artificial neural network.

FIG. 2 illustrates a flow chart of another method for determining particle content in a fluid according to an embodiment of the present disclosure. With respect to method 100 shown in FIG. 1, method 200 shown in FIG. 2 includes an additional step S210. After acquiring the image of the fluid (step S110), and before determining the particle-related characteristic value (S120), e.g. a step S210 of preprocessing the image may be performed. Preprocessing the image includes segmenting the image to obtain a preprocessed image with a predetermined size and a predetermined position, normalizing the values of the pixels in the image, removing noise of the image, and converting the image to an image with a predetermined format.

Since the acquired image most likely includes objects other than fluid in addition to the fluid itself, and the fluid sample placed on the slide may have irregular contours, preprocessing of the acquired image is required. The acquired image may be segmented into a plurality of sub-images, and one or more sub-images in the middle of the image may be taken as the preprocessed image. Thus, the preprocessed image can exhibit homogeneous properties of a fluid, e.g. a lubricating oil or a lubricating fluid, within a predetermined range.

In addition, the values of the pixels in the image may be normalized for faster processing of the image data. The values of the pixels in the image are E.g., integers between 0 and 255, the normalization of the values of the pixels may be achieved by dividing the values of all the pixels by the value of 255, which is the largest pixel.

In order to show the particles in the image more clearly for easy observation and identification of the particles, the image may also be de-noised and converted into an image with a predetermined format. According to an embodiment of the present disclosure, the predetermined format includes an RGB format and an HSV format. The image may e.g. be converted to R (red), G (green), or B (blue) format in RGB format, or to H (hue), S (saturation), or V (value/luminance) format in HSV format. Preferably, the image can be converted to V (value/luminance) format so that the particles can be more clearly displayed.

According to an embodiment of the present disclosure, a regression model may be utilized to describe the relationship between the particle-related characteristic value and the particle content and determine the particle content from the particle-related characteristic value. In constructing the regression model, one or more particle-related characteristic values are first selected, e.g. as described in detail above, the mean and variance of the values of the pixels in the image, the number and total area of particles, and the variance of the values of the pixels after removing the particles from the image and after removing the noise of the image. A type of regression model suitable for the particle-related characteristic value is then selected, the selected regression model comprising a plurality of adjustable parameters, and the particle-related characteristic value is input into the regression model, and by adjusting these parameters different predictions of the particle content can be obtained, adjusting these parameters so that the individual predictions of the particle content converge to the corresponding known particle content. The overall difference of the predicted value of the respective particle content from the corresponding known particle content can be calculated, e.g., by a least squares method. When the difference between the two is minimal, the parameter being adjusted is the optimal solution, at which point a regression model is built. The more historical data is used, the more accurate the regression model, i.e. the fitted functional relationship between the particle-related characteristic values and the particle content.

According to an embodiment of the present disclosure, a plurality of sub-regression models may be included in the regression model. For example, a first sub-regression model is built for historical data with low particle content (e.g., less than the first particle content threshold), a second sub-regression model is built for historical data with medium particle content (e.g., greater than the first particle content threshold less than the second particle content threshold), and a third sub-regression model is built for historical data with high particle content (e.g., greater than the second particle content threshold). Since the particle content may be distributed over a large range, e.g. between 0 PPM and 1*10⁶ PPM (parts per million), a regression model may have difficulty accurately describing the relationship between particle content and the particle-related characteristic values for the entire content range. Thus, by employing a plurality of sub-regression models, the relationship of the content of the particles to the particle-related characteristic values can be described relatively accurately in the respective content range.

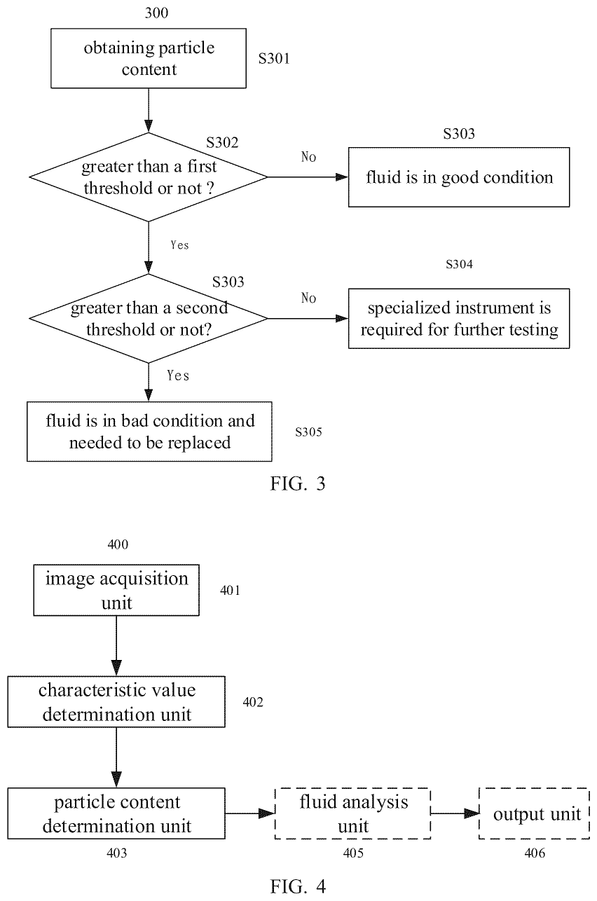

FIG. 3 illustrates a flow diagram of a method for determining a state of a fluid according to a particle content in the fluid, in accordance with an embodiment of the present disclosure. According to an embodiment of the present disclosure, the method further includes: a first threshold value and a second threshold value are predetermined, wherein the fluid is additionally detected in the event that the particle content is greater than said first threshold and less than said second threshold, and wherein the fluid is replaced in the event that the particle content is greater than the second threshold. In FIG. 3, the particle content in the fluid is first obtained (step S301). The particle content is then compared with a predetermined first threshold value (step S302). If the particle content is less than a predetermined first threshold value, the fluid is considered to be in good condition and the replacement operation is not to be performed. If the particle content is greater than the predetermined first threshold value, the particle content is compared with a predetermined second threshold value (step S303). If the particle content is less than the second predetermined threshold value, a specialized instrument is required for further testing (step S304), and if the particle content is greater than the second predetermined threshold value, the fluid is deemed to be in bad condition and needed to be replaced (step S305).

The iron particle content in a lubricating fluid or oil is in units of parts per million (PPM). For a lubricating fluid or oil that does not need to be replaced, the iron particle content is about a few hundred PPM, whereas for a lubricating fluid or oil that must be replaced, the iron particle content may be in the thousands of PPM. Thus, e.g., it is possible to set a first threshold value, e.g. 800, 1000 or 1200 PPM, below which the condition of the lubricating fluid or oil is considered to be in good condition and no replacement operation is required. Above the first threshold, e.g., the lubricating fluid or the lubricating oil may be considered to be in poor condition and must be replaced. More preferably, a second threshold may also be set, e.g. 2000 PPM. If the particle content is greater than the first threshold value and less than the second threshold value, a further, more detailed detection of the lubricating oil or lubricating fluid can be performed by the further detection device and the lubricating oil or lubricating fluid can only be replaced if the particle content is greater than the second threshold value.

By setting the first threshold value and the second threshold value, it is possible, on the one hand, to allow maintenance personnel to quickly identify a lubricating fluid or oil which is in good condition and which does not need to be replaced at all, and, on the other hand, to prolong the use of the lubricating fluid or oil, i.e. to temporarily not replace the lubricating fluid or oil in case the state of the lubricating fluid or oil is not good but still acceptable.

FIG. 4 illustrates a structural schematic diagram of apparatus 400 for determining particle content in a fluid according to an embodiment of the present disclosure. Apparatus 400 may include an image acquisition unit 401, a characteristic value determination unit 402, and a particle content determination unit 403. The image acquisition unit 401 is configured to acquire an image of the fluid and to feed the image of the fluid to the characteristic value determination unit 402. The characteristic value determination unit 402 is configured to determine a particle-related characteristic value in the image. The particle content determination unit 403 is configured to determine the particle content from the particle-related characteristic value.

According to an embodiment of the present disclosure, apparatus 400 may further include a fluid analysis unit 405 and an output unit 406. The fluid analysis unit 405 is configured to determine an analysis result related to the fluid based on the particle content and to transmit the analysis result to the output unit 406. The output unit 406 is configured to output the analysis result.

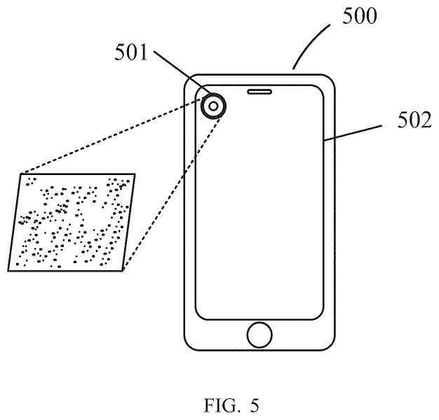

FIG. 5 illustrates a schematic view of apparatus 500 for determining particle content in a fluid according to an embodiment of the present disclosure. In FIG. 5, apparatus 500 is designed as a smartphone having a camera 501 as an image acquisition unit, a display 502 as an output unit and a processor contained therein. The camera 501 may be arranged, e.g., on the front or back of the smartphone. As shown in FIG. 5, camera 501 takes an image of the fluid to be examined, which image contains particles. The image may, e.g., be an image of a lubricating fluid or oil containing iron particles. An application program for performing the method according to the above embodiment is stored in a processor in the smartphone, for example, and steps S120-S130, S210, and S301-S305 of the method in the above embodiment may be performed.

By implementing the apparatus according to the present disclosure as a smartphone, a maintenance person can conveniently determine the iron particle content in the lubricating fluid or oil in the mechanical device at the site of the mechanical device using the smartphone on his or her own, thereby promptly judging whether a change of the lubricating oil or the lubricating fluid is required.

According to an embodiment of the present disclosure, the apparatus may also be a tablet or be glasses or a watch with a photo function.

Embodiments of the present disclosure also provide a computer readable medium on which is stored a computer program product which can be directly loaded into a memory unit of a programmable computing unit, the computer program product having program code means for performing the method according to the above embodiments when the computer program product is implemented in the computing unit.

The method, the apparatus and the computer-readable medium according to the present disclosure may enable the content of particles, e.g. iron particles, to be determined in a fluid to be tested, e.g. a lubricating fluid or a lubricating oil, only by means of an image thereof. Therefore, the maintenance personnel of the machine device can easily and quickly perform the test in the field and can immediately judge whether the lubrication fluid or lubrication needs to be replaced, so that there is no need to take a sample of the fluid back to the laboratory for the test and no need to use a special test device for the test.

The block diagrams of circuits, units, devices, apparatuses, equipments and systems referred to in this disclosure are merely illustrative examples and are not intended to require or imply that the connections, arrangements, configurations must be made in the manner shown in the block diagrams. As will be appreciated by a person skilled in the art, these circuits, units, devices, apparatuses, equipments and systems may be connected, arranged, configured in any way as long as the intended purpose is achieved. The circuits, units, devices, apparatus involved in the present disclosure may be implemented in any suitable manner, e.g., in an Application Specific Integrated Circuit, a Field Programmable Gate Array (FPGA), etc., or in a general-purpose processing unit in combination with a known program.

It should be understood by those skilled in the art that the above-described specific embodiments are only examples and not limitations, and various modifications, combinations, partial combinations and substitutions may be made to the embodiments of the present disclosure according to design requirements and other factors as long as they are within the scope of the appended claims or the equivalent thereof, i.e., the scope of the right to be protected by the present disclosure.

What is claimed is:

1. A method for determining particle content in a fluid, comprising:
acquiring an image of the fluid,
determining a particle-related characteristic value in the image, and
determining the particle content from the particle-related characteristic value.

2. The method of claim 1, wherein the particle-related characteristic value comprises:
a statistical characteristic value of the values of the pixels in the image,
the number, density and total area of the particles,
a statistical characteristic value of the values of the pixels after removing the particles from the image, and
a statistical characteristic value of the values of the pixels after removing the particles from the image and removing noise of the image.

3. The method of claim 2, wherein the statistical characteristic value of the values of the pixels in the image comprises:
a mean, a variance, a skewness, and a kurtosis of the values of the pixels in the image.

4. The method of claim 1, wherein determining the particle-related characteristic value in the image comprises:
preprocessing the image, wherein preprocessing the image comprises:
segmenting the image to obtain a preprocessed image with a predetermined size and a predetermined position,
normalizing the values of the pixels in the image,
removing noise of the image, and
converting the image into an image with a predetermined format.

5. The method of claim 4, wherein the predetermined format comprises an RGB format and an HSV format.

6. The method of claim 1, wherein determining the particle content from the particle-related characteristic value comprises:
determining the particle content from the particle-related characteristic value based on a regression model,
wherein the regression model describes a relationship between the particle-related characteristic values and the particle content.

7. The method of claim 1, wherein the method further comprises:
determining that further detection of the fluid is required in the event that the particle content is greater than a first threshold and less than a second threshold, wherein the first threshold is less than the second threshold,
determining that a replacement of the fluid is required in the event that the particle content is greater than the second threshold.

8. A computer readable medium having a computer program product stored on the computer readable medium which can be directly loaded into a memory unit of a programmable computing unit, the computer program product having program code means for performing the method of claim 1 when the computer program product is implemented in the computing unit.

9. A computer readable medium having a computer program product stored on the computer readable medium which can be directly loaded into a memory unit of a programmable computing unit, the computer program product having program code means for performing the method of claim 7 when the computer program product is implemented in the computing unit.

10. An apparatus for determining particle content in a fluid, comprising:
an image acquisition unit for acquiring an image of the fluid;
a characteristic value determination unit for determining a particle-related characteristic value in the image; and
a particle content determination unit for determining the particle content from the particle-related characteristic value.
